(19) United States
(12) Patent Application Publication
(10) Pub. No.: US 2014/0132587 A1
(43) Pub. Date: May 15, 2014

(54) Integrated Source Driver and Liquid Crystal Display Device Using the Same

(71) Applicant: NOVATEK Microelectronics Corp., Hsin-Chu (TW)

(72) Inventors: Po-Yu Tseng, Taoyuan County (TW); Chia-Wei Su, Hsinchu City (TW); Po-Hsiang Fang, Hsinchu City (TW); Shun-Hsun Yang, Hsinchu City (TW); Hsin-Hung Lee, Kaohsiung City (TW)

(73) Assignee: NOVATEK Microelectronics Corp., Hsin-Chu (TW)

(21) Appl. No.: 13/957,440

(22) Filed: Aug. 2, 2013

(30) Foreign Application Priority Data
Nov. 13, 2012 (TW) 101142202

(51) Int. Cl. G09G 3/36

(52) U.S. Cl. CPC G09G 3/3696
USPC 345/212; 345/87

(57) ABSTRACT

The present invention discloses an integrated source driver for a liquid crystal display device. The integrated source driver includes a reference voltage generating circuit, for providing a plurality of adjustable voltage ranges within a supply voltage and a ground level, and a reference voltage selecting circuit, including a plurality of digital to analog converters, for selecting and generating a plurality of internal reference voltages from the plurality of adjustable voltage ranges, respectively. The plurality of adjustable voltage ranges decrease progressively.

### BACKGROUND OF THE INVENTION

1. Field of the Invention

The present invention relates to an integrated source driver and a liquid crystal display device thereof, and more particularly, to an integrated source driver and a liquid crystal display device thereof capable of integrating an external reference voltage generator and limiting generated adjustable voltage ranges of each internal reference voltage, to save hardware cost or increase voltage adjustment resolution.

2. Description of the Prior Art

Owing to the low price and high quality, liquid crystal display devices have been widely used in information products such as notebooks, Personal Digital Assistants (PDAs), Mobile phones, and watches.

A liquid crystal display device is mainly composed of single or a plurality of source drivers, single or a plurality of gate drivers and a panel. The source drivers and the gate drivers are used for controlling crisscrossing data lines and scan lines in the panel, and a thin film transistor is connected to intersections of each data line and scan line (i.e. the thin film transistors are distributed as a matrix on the panel, and each thin film transistor corresponds to a pixel). A conventional source driver needs to receive multiple external reference voltages to output a correct voltage to a data line, so as to drive a pixel of a panel of a liquid crystal display device for displaying. Therefore, reference voltages play important parts. In many applications, an additional reference voltage generator is utilized to strengthen the driving capability of the reference voltages and stabilize the reference voltages.

Besides, in a conventional panel application, the output voltages of the source drivers are changed by adjusting reference voltages, so as to adjust a screen color. Therefore, the reference voltage generator providing reference voltages to source drivers needs to be capable of adjusting to the reference voltages.

Please refer to FIG. 1, which is a schematic diagram of a conventional source driver 10 receiving positive gamma reference voltages VPR₁-VPRₘ and negative gamma reference voltages VNR₁-VNRₘ from an external reference voltage generator 12. As shown in FIG. 1, after the conventional source driver 10 receives positive gamma reference voltages VPR₁-VPRₘ and negative gamma reference voltages VNR₁-VNRₘ from the external reference voltage generator 12 and then the positive gamma reference voltages VPR₁-VPRₘ and the negative gamma reference voltages VNR₁-VNRₘ are processed by a positive polarity gamma correction resistor 102 and a negative polarity gamma correction resistor 104, the conventional source driver 10 outputs correct voltages to data lines for driving corresponding pixels by a digital to analog converter (DAC) and related circuits. This part is well-known for those skilled in the art, and hence is not narrated hereinafter.

In such a situation, to save a system cost and dynamically adjust reference voltages, the external reference voltage generator 12 and the conventional source driver 10 are further integrated into an integrated source driver in the prior art, such that multiple reference voltages are generated inside the integrated source driver by a single controlling method.

Noticeably, in order to adapt to different applications, each reference voltage outputted by the conventional external reference voltage generator 12 needs to be adjustable by a controlling mechanism, and the conventional external reference voltage generator 12 needs to provide rail-to-rail adjustable ranges (i.e. each reference voltage is adjustable within a supply voltage and a ground level of the external reference voltage generator 12).

However, if the conventional external reference voltage generator 12 and the conventional source driver 10 are directly integrated into the integrated source driver, and if the adjustable ranges of the reference voltages are still the same with the rail-to-rail adjustable ranges of the conventional external reference voltage generator 12 while high resolution is maintained, the hardware cost is quite large because the source driver 10 requires more reference voltages. Thus, there is a need for improvement of the prior art.

### SUMMARY OF THE INVENTION

It is therefore an objective of the present invention to provide an integrated source driver and a liquid crystal display device thereof capable of integrating external reference voltage devices and limiting generated adjustable voltage ranges of each internal reference voltage, to save hardware cost or increase voltage adjustment resolution.

The present invention discloses an integrated source driver for a liquid crystal display device. The integrated source driver comprises a reference voltage generating circuit, for providing a plurality of adjustable voltage ranges within a supply voltage and a ground level; and a reference voltage selecting circuit, comprising a plurality of digital to analog converters (DACs), for selecting and generating a plurality of internal reference voltages from the plurality of adjustable voltage ranges according to a control signal, respectively; wherein the plurality of adjustable voltage ranges decrease progressively.

The present invention further discloses a liquid crystal display device, comprising a plurality of data lines; and a plurality of integrated source drivers, for driving pixels of corresponding data lines in the plurality of data lines, respectively. A first integrated source driver in the plurality of integrated source drivers comprises a reference voltage generating circuit, for providing a plurality of adjustable voltage ranges within a power supply voltage and a ground level; and a reference voltage selecting circuit, comprising a plurality of digital to analog converters (DACs), for selecting and generating a plurality of first internal reference voltages from the plurality of adjustable voltage ranges according to a control signal, respectively; wherein the plurality of adjustable voltage ranges decrease progressively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional source driver receiving positive gamma reference voltages and negative gamma reference voltages from an external reference voltage generator.

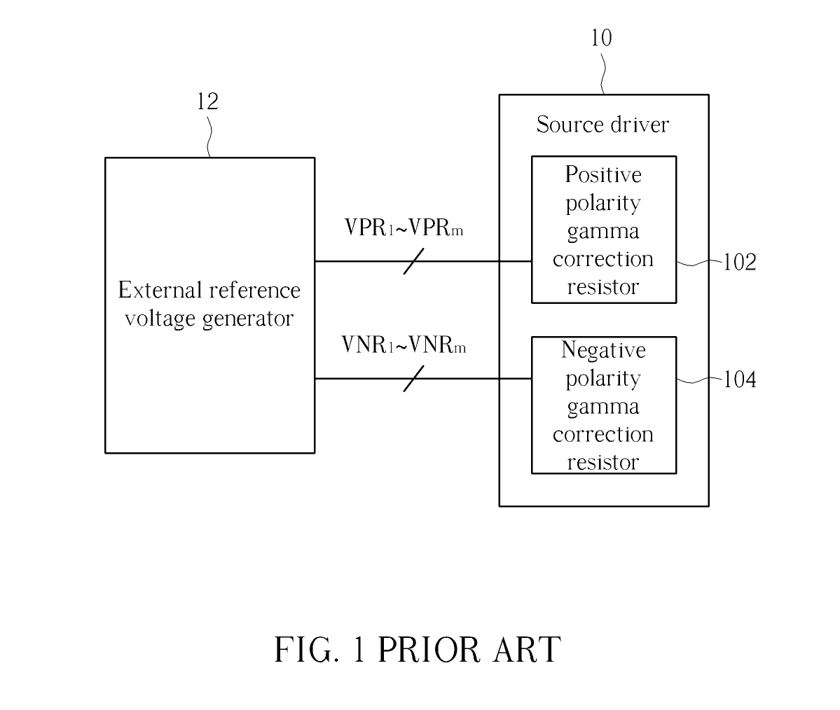

FIG. 2 is a schematic diagram of an integrated source driver according to an embodiment of the present invention.

FIG. 3 is a diagram of an output voltage curve.

FIG. 4 is a diagram of adjustable voltage ranges shown in FIG. 2.

FIG. 5 is a schematic diagram of an integrated source driver for realizing the integrated source driver shown in FIG. 2.

FIG. 6 is a schematic diagram of another integrated source driver according to an embodiment of the present invention.

FIG. 7 is a schematic diagram of a further integrated source driver according to an embodiment of the present invention.

FIG. 8 is a schematic diagram of a further integrated source driver according to an embodiment of the present invention.

FIG. 9 is a schematic diagram of a further integrated source driver according to an embodiment of the present invention.

FIG. 10 is a schematic diagram of two integrated source drivers in a panel application according to an embodiment of the present invention.

FIG. 11 is a schematic diagram of another two integrated source drivers in a panel application according to an embodiment of the present invention.

FIG. 12 a schematic diagram of three integrated source drivers in a panel application according to an embodiment of the present invention.

FIG. 13 a schematic diagram of an integrated source driver and two source drivers in a panel application according to an embodiment of the present invention.

FIG. 14 is a detailed schematic diagram of the integrated source driver shown in FIG. 5.

### DETAILED DESCRIPTION

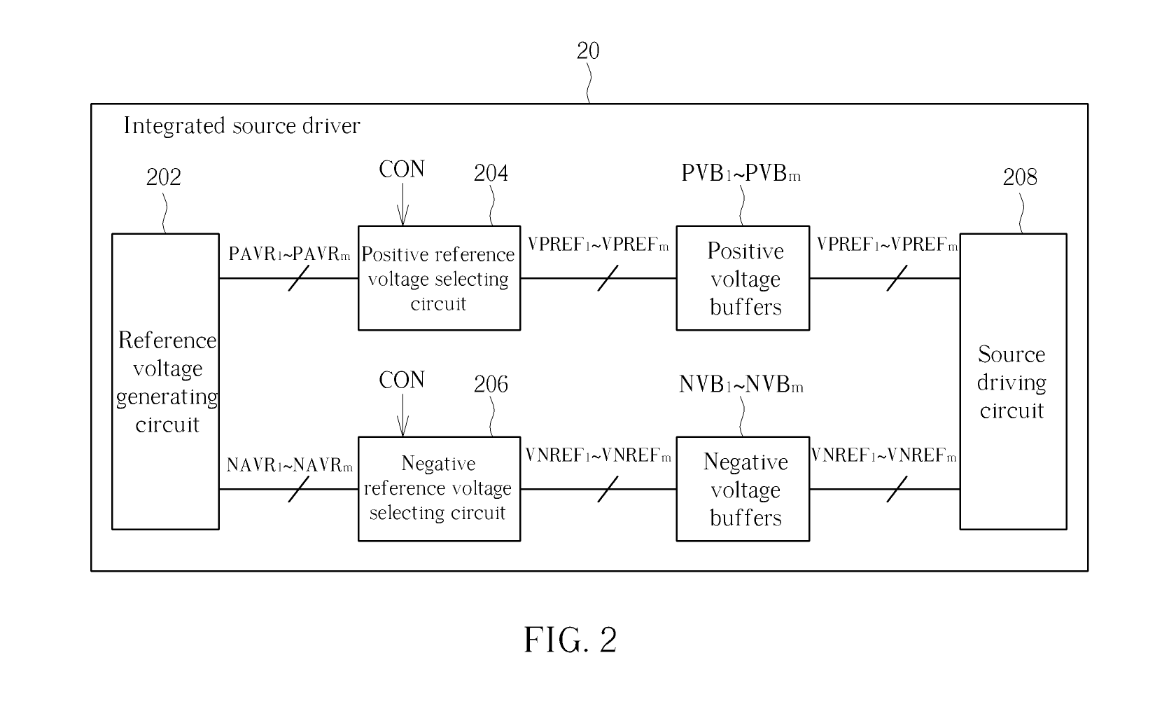

Please refer to FIG. 2, which is a schematic diagram of an integrated source driver 20 according to an embodiment of the present invention. As shown in FIG. 2, the integrated source driver 20 includes a reference voltage generating circuit 202, a positive reference voltage selecting circuit 204, a negative reference voltage selecting circuit 206, positive voltage buffers PVB₁-PVBₘ, negative voltage buffers NVB₁-NVBₘ and a source driving circuit 208.

In short, the reference voltage generating circuit 202 provides positive adjustable voltage ranges PAVR₁-PAVRₘ and negative adjustable voltage ranges NAVR₁-NAVRₘ within a supply voltage VS and a ground level GND for the reference voltage selecting circuit 204 and 206. The reference voltage selecting circuit 204 and 206 includes digital to analog converters (DACs) PDAC₁-PDACₘ, NDAC₁-NDACₘ (not shown in FIG. 2), for selecting and generating internal reference voltages VPREF₁-VPREFₘ, VNREF₁-VNREFₘ within the adjustable voltage ranges PAVR₁-PAVRₘ, NAVR₁-NAVRₘ for the voltage buffers PVB₁-PVBₘ, NVB₁-NVBₘ according to a digital control signal CON, respectively. The voltage buffer PVB₁-PVBₘ, NVB₁-NVBₘ maintains voltage levels to stably output the internal reference voltages VPREF₁-VPREFₘ, VNREF₁-VNREFₘ for source driving circuit 208 after buffering the internal reference voltages VPREF₁-VPREFₘ, VNREF₁-VNREFₘ, such that the source driving circuit 208 performs driving according to the internal reference voltage VPREF₁-VPREFₘ, VNREF₁-VNREFₘ. The adjustable voltage ranges PAVR₁-PAVRₘ, NAVR₁-NAVRₘ decrease progressively (i.e. the internal reference voltages VPREF₁-VPREFₘ, VNREF₁-VNREFₘ decrease progressively), and a structure and an operating of the source driving circuit 208 are similar to those of the conventional source driver 10.

In such a situation, since the adjustable voltage ranges PAVR₁-PAVRₘ, NAVR₁-NAVRₘ distribute within the supply voltage VS and the ground level GND in a decreasing manner, the corresponding digital to analog converters PDAC₁-PDACₘ, NDAC₁-NDACₘ adjust the internal reference voltages VPREF₁-VPREFₘ, VNREF₁-VNREFₘ within each adjustable voltage ranges PAVR₁-PAVRₘ, NAVR₁-NAVRₘ instead of within the supply voltage VS and the ground level GND. As a result, since adjustable ranges of the internal reference voltage VPREF₁-VPREFₘ, VNREF₁-VNREFₘ are smaller in the integrated source driver 20, the present invention saves the hardware cost for the same voltage adjustment resolution, or increases the voltage adjustment resolution for the same hardware cost.

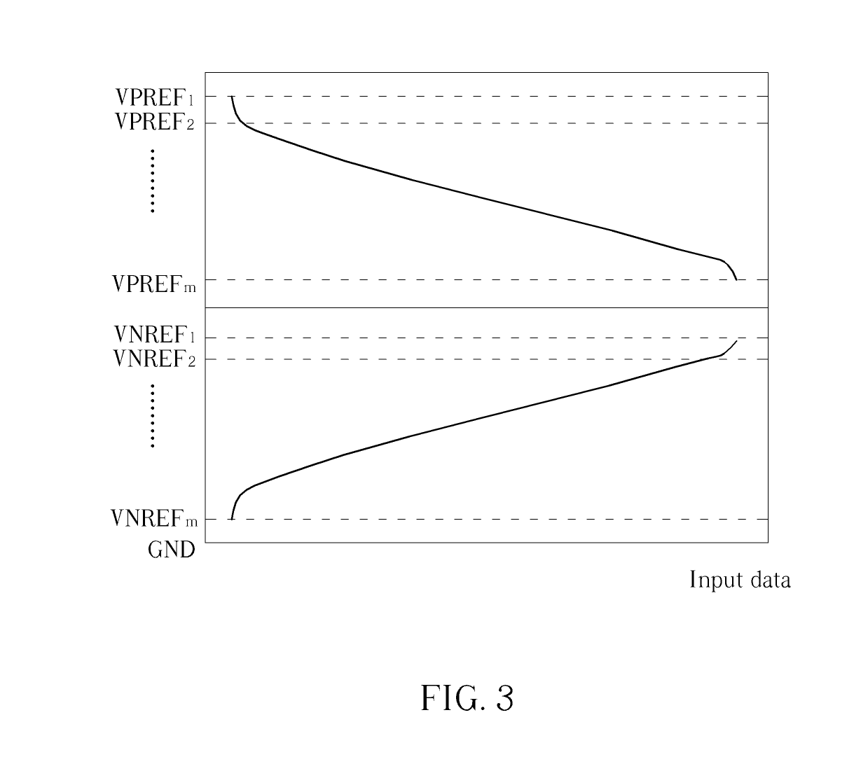

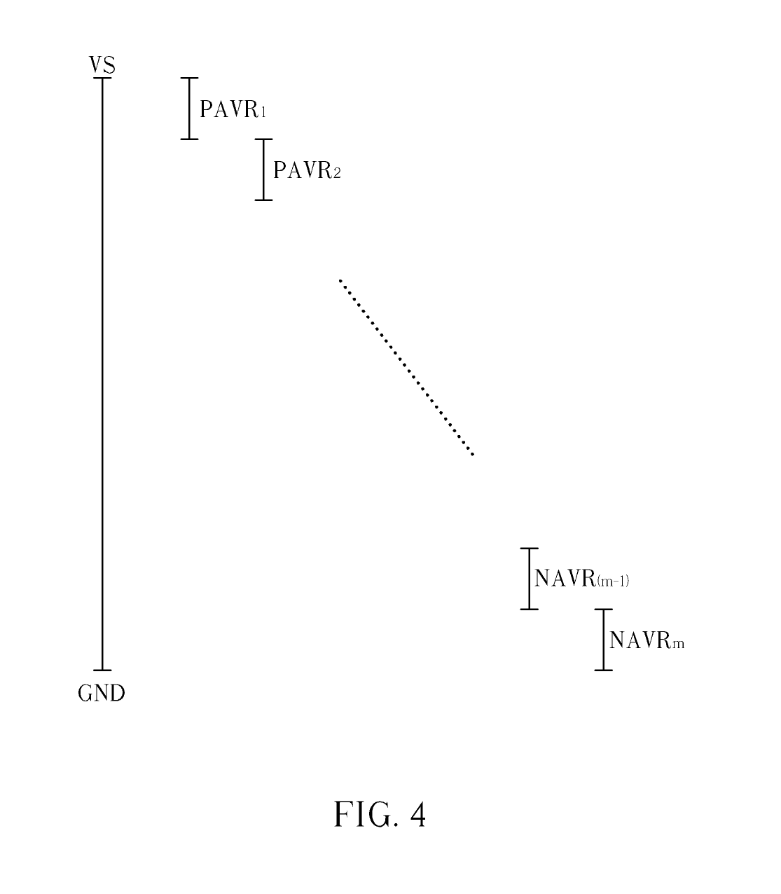

In detail, please refer to FIGS. 3 and 4. FIG. 3 is a schematic diagram of an output voltage curve. FIG. 4 is a schematic diagram of adjustable voltage ranges PAVR₁-PAVRₘ, NAVR₁-NAVRₘ shown in FIG. 2. As shown in FIG. 3, the internal reference voltages VPREF₁-VPREFₘ, VNREF₁-VNREFₘ employed in the panel application are corresponding to respective input data in the output voltage curve (i.e. a gamma curve). Since the internal reference voltages VPREF₁-VPREFₘ, VNREF₁-VNREFₘ required by the source driving circuit 208 is divided into positive and negative polarities and decrease progressively from positive to negative (or increase progressively from negative to positive), the adjustable ranges of the internal reference voltages VPREF₁-VPREFₘ, VNREF₁-VNREFₘ are not required to be rail-to-rail as those in the conventional external reference voltage generator 12 (i.e. all adjustable within the supply voltage VS and the ground level GND) when the integrated source driver 20 generates the internal reference voltages VPREF₁-VPREFₘ, VNREF₁-VNREFₘ inside via integration. A maximum and a minimum values of the adjustable voltage ranges PAVR₁-PAVRₘ, NAVR₁-NAVRₘ of the internal reference voltages VPREF₁-VPREFₘ, VNREF₁-VNREFₘ can be optimized—according to a gamma curve in practical applications.

Specifically, as shown in FIG. 4, since the internal reference voltages VPREF₁-VPREFₘ, VNREF₁-VNREFₘ decrease progressively, the adjustable voltage ranges PAVR₁-PAVRₘ, NAVR₁-NAVRₘ in the integrated source driver 20 are designed to be minimized to specific ranges distributed within the supply voltage VS and the ground level GND, respectively. Noticeably, although the adjustable voltage ranges PAVR₁-PAVRₘ, NAVR₁-NAVRₘ shown in FIG. 4 do not overlap with each other, the adjustable voltage ranges PAVR₁-PAVRₘ, NAVR₁-NAVRₘ may partially overlap with each other according to different panel applications in other embodiments. As a result, since the adjustable voltage ranges PAVR₁-PAVRₘ, NAVR₁-NAVRₘ are smaller than the rail-to-rail adjustable ranges within the supply voltage VS and the ground level GND, the present invention can save the hardware cost for the same voltage adjustment resolution or increase the voltage adjustment resolution for the same hardware cost.

For example, since the adjustable range of each reference voltage in the conventional external reference voltage generator 12 is rail-to-rail, assume that the supply voltage VS is 16V, if a 10-bit digital to analog converter is utilized, the adjustment resolution of each level is 16V/1024=15.6 mV. In comparison, the integrated source driver 20 in the present invention is capable of limiting each adjustable voltage range of the adjustable voltage ranges PAVR₁-PAVRₘ, NAVR₁-NAVRₘ to 2V based on practical applications. In such a condition, in one embodiment, the present invention can design each digital to analog converter in the reference voltage selecting circuit 204, 206 to be 7-bit for an adjustment resolution of 2V/128=15.6 mV for each level, and thus saves the hardware cost. In another embodiment, the present invention can design each digital to analog converter in the reference voltage selecting circuit 204, 206 to be 10-bit for an adjustment resolution of 2V/1024<2 mV for each level, and thus increases the voltage adjustment resolution. As a result, the present invention can generate the smaller adjustable voltage ranges PAVR₁-PAVRₘ, NAVR₁-NAVRₘ of the internal reference voltage VPREF₁-VPREFₘ, VNREF₁-VNREFₘ in the integrated source driver 20 according to practical applications, and therefore, achieves higher adjustable resolution for the same hardware cost or requires less hardware for the same resolution compared to the conventional external reference voltage generator 12.

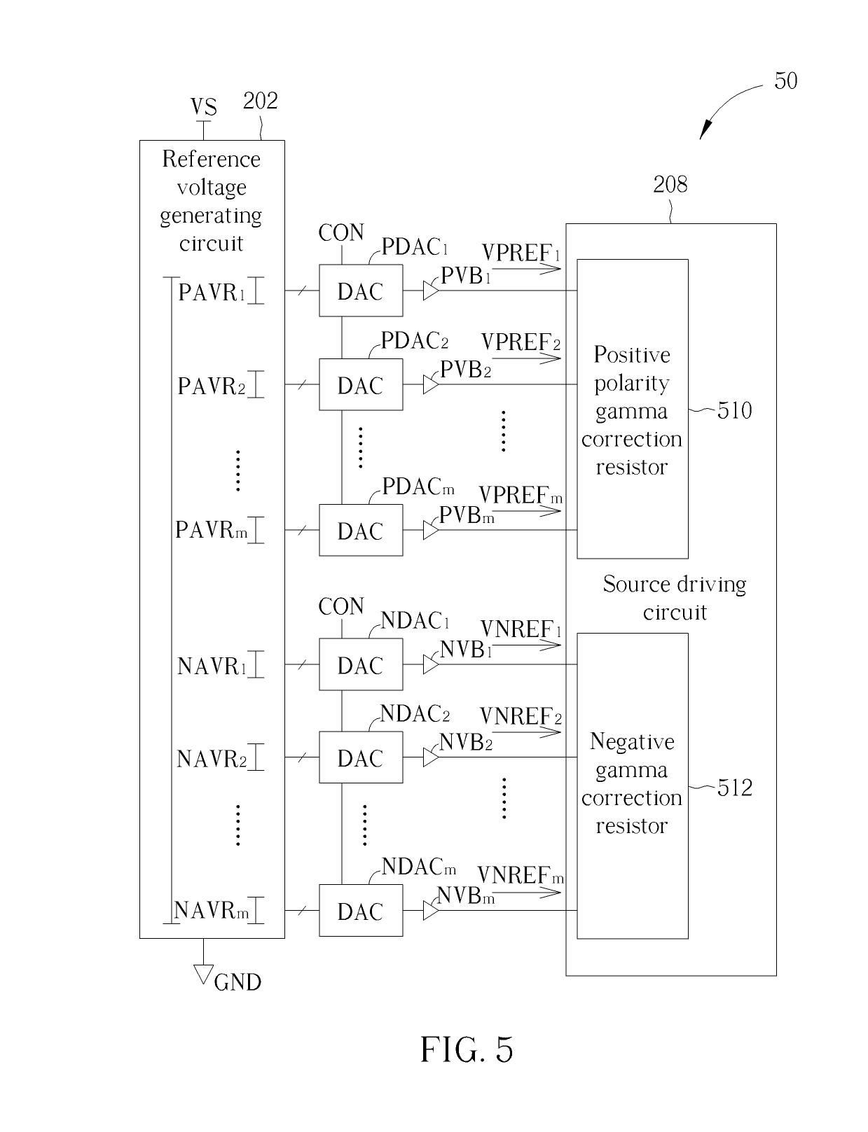

Specifically, please refer to FIG. 5, which is a schematic diagram of an integrated source driver 50 for realizing the integrated source driver 20 shown in FIG. 2. As shown in FIG. 5, the integrated source driver 50 is a detailed schematic diagram of the integrated source driver 20, and thus elements with similar functions and signals are denoted by the same symbol. The reference voltage generating circuit 202 directly generates positive adjustable voltage ranges PAVR₁-PAVRₘ, negative adjustable voltage ranges NAVR₁-NAVRₘ for the corresponding digital to analog converters PDAC₁-PDACₘ, NDAC₁-NDACₘ within the supply voltage VS and the ground level GND by resistor division voltages or other methods, such that the digital to analog converters PDAC₁-PDACₘ, NDAC₁-NDACₘ select and output the corresponding internal reference voltages VPREF₁-VPREFₘ, VNREF₁-VNREFₘ within the adjustable voltage ranges PAVR₁-PAVRₘ, NAVR₁-NAVRₘ according to the received control signal CON, respectively (i.e. each of the internal reference voltages VPREF₁-VPREFₘ, VNREF₁-VNREFₘ is corresponding to a specific voltage level corresponding to a specific digital code of the control signal CON). Then the voltage buffers PVB₁-PVBₘ, NVB₁-NVBₘ stably output the internal reference voltages VPREF₁-VPREFₘ, VNREF₁-VNREFₘ for a positive polarity gamma correction resistor 510 and a negative gamma correction resistor 512 of the source driving circuit 208 by feedback for following operations. The digital codes of the control signal CON for each of the digital to analog converters PDAC₁-PDACₘ, NDAC₁-NDACₘ to generate the respective internal reference voltage VPREF₁-VPREFₘ, VNREF₁-VNREFₘ, are not all the same (e.g. the internal reference voltage VPREF₁ can be at the upper bound of the adjustable voltage range PAVR₁ and the internal reference voltage VPREF₂ can be at the lower bound of the adjustable voltage range PAVR₂). Under this structure, the present invention can adjust bit numbers of the digital to analog converters PDAC₁-PDACₘ, NDAC₁-NDACₘ, so as to save the hardware cost for the same voltage adjustment resolution or increase the voltage adjustment resolution for the same hardware cost.

Noticeably, the spirit of the present invention is to minimize the corresponding adjustable voltage ranges PAVR₁-PAVRₘ, NAVR₁-NAVRₘ according to practical applications when generating the internal reference voltages VPREF₁-VPREFₘ, VNREF₁-VNREFₘ via integration, to achieve higher adjustable resolution for the same hardware cost, or require less hardware for the same resolution. Those skilled in the art can make modifications or alterations accordingly. For example, the reference voltage generating circuit 202 in the embodiment shown in FIG. 5 directly generates adjustable voltage ranges PAVR₁-PAVRₘ, NAVR₁-NAVRₘ within the supply voltage VS and the ground level GND by resistor division voltages or other methods. However, the reference voltage generating circuit 202 in other embodiments may receive external reference voltages and generate the adjustable voltage ranges PAVR₁-PAVRₘ, NAVR₁-NAVRₘ accordingly.

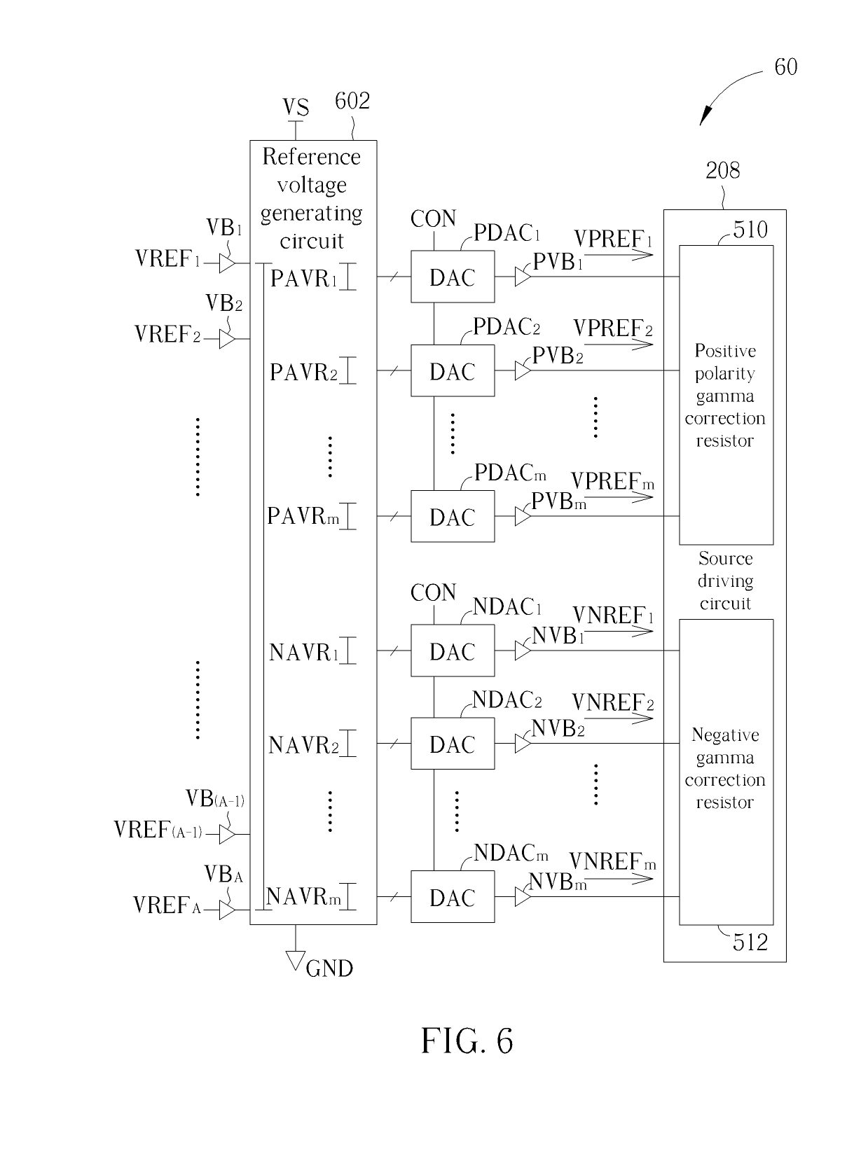

For example, please refer to FIG. 6, which is a schematic diagram of another integrated source driver 60 according to an embodiment of the present invention. As shown in FIG. 6, the integrated source driver 60 and the integrated source driver 50 shown in FIG. 5 are the same in parts, and thus elements and signals with similar functions are denoted by the same symbol. Main differences between the integrated source driver 60 and the integrated source driver 50 are that a reference voltage generating circuit 602 included in the integrated source driver 60 further receives external reference voltages VREF₁-VREF_{A}, and provides at least one of the adjustable voltage ranges PAVR₁-PAVRₘ, NAVR₁-NAVRₘ within the supply voltage VS and the ground level GND according to the external reference voltage VREF₁-VREF_{A}.

In such a condition, compared to the reference voltage generating circuit 202 shown in FIG. 5 which directly generates the adjustable voltage ranges PAVR₁-PAVRₘ, NAVR₁-NAVRₘ within the supply voltage VS and the ground level GND and thus may cause the adjustable voltage ranges PAVR₁-PAVRₘ, NAVR₁-NAVRₘ to deviate from an ideal value when the supply voltage VS is unstable, the reference voltage generating circuit 602 shown in FIG. 6 receives stable external reference voltages VREF₁-VREF_{A}, which are provided and buffered by the voltage buffers VB₁-VB_{A}, as reference voltage points. Therefore, the reference voltage points within the supply voltage VS and the ground level GND are stable, and are capable of generating stable adjustable voltage ranges PAVR₁-PAVRₘ, NAVR₁-NAVRₘ. Noticeably, the present invention generates the internal reference voltages VPREF₁-VPREFₘ, VNREF₁-VNREFₘ via integration, to reduce the external reference voltage points, and hence saves the system cost and dynamically adjusts the reference voltages. Therefore, the number of the external reference voltages VREF₁-VREF_{A} received from an external system in FIG. 6 should be less than that of the required internal reference voltages VPREF₁-VPREFₘ, VNREF₁-VNREFₘ (i.e. A<2m), to achieve the advantages of integration.

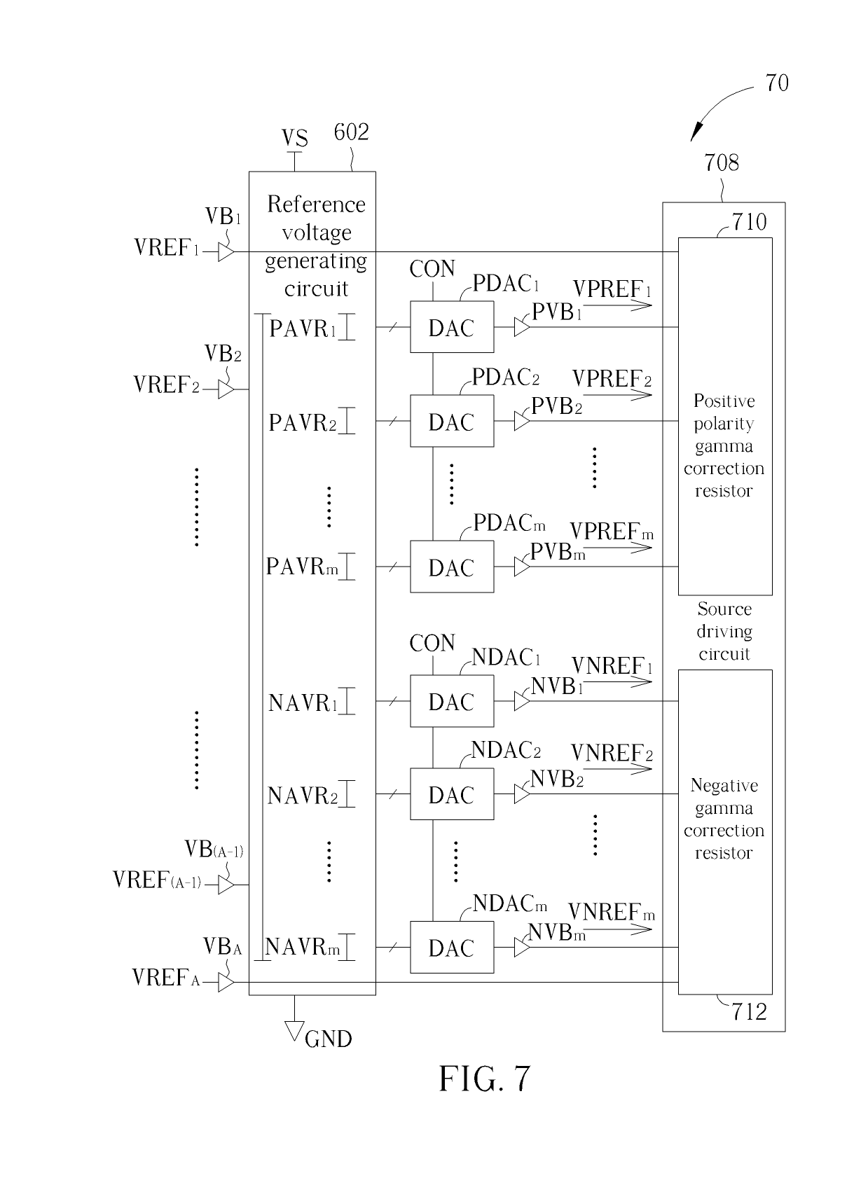

Besides, please refer to FIG. 7, which is a schematic diagram of a further integrated source driver 70 according to an embodiment of the present invention. As shown in FIG. 7, the integrated source driver 70 and the integrated source driver 60 are the same in parts, and thus elements and signals with the similar functions are denoted by the same symbol. The main difference between the integrated source driver 70 and the integrated source driver 60 is that a source driving circuit 708 included in the integrated source driver 70 receives external reference voltage VREF₁, VREF_{A} by a positive polarity gamma correction resistor 710 and a negative polarity gamma correction resistor 712, and then performs driving according to internal reference voltages VPREF₂-VPREFₘ, VNREF₁-VNREFₘ₋₁ and external reference voltages VREF₁, VREF_{A}. In such a condition, since external reference voltages VREF₁, VREF_{A} can also be adjusted within specific voltage ranges, the source driving circuit 708 can directly receive the external reference voltage VREF₁, VREF_{A} from an external system, to replace the internal reference voltage VPREF₁, VNREFₘ generated by the internal system shown in FIG. 6, so as to save a hardware cost of corresponding digital to analog converters PDAC₁, NDACₘ and positive voltage buffers PVB₁, NVBₘ.

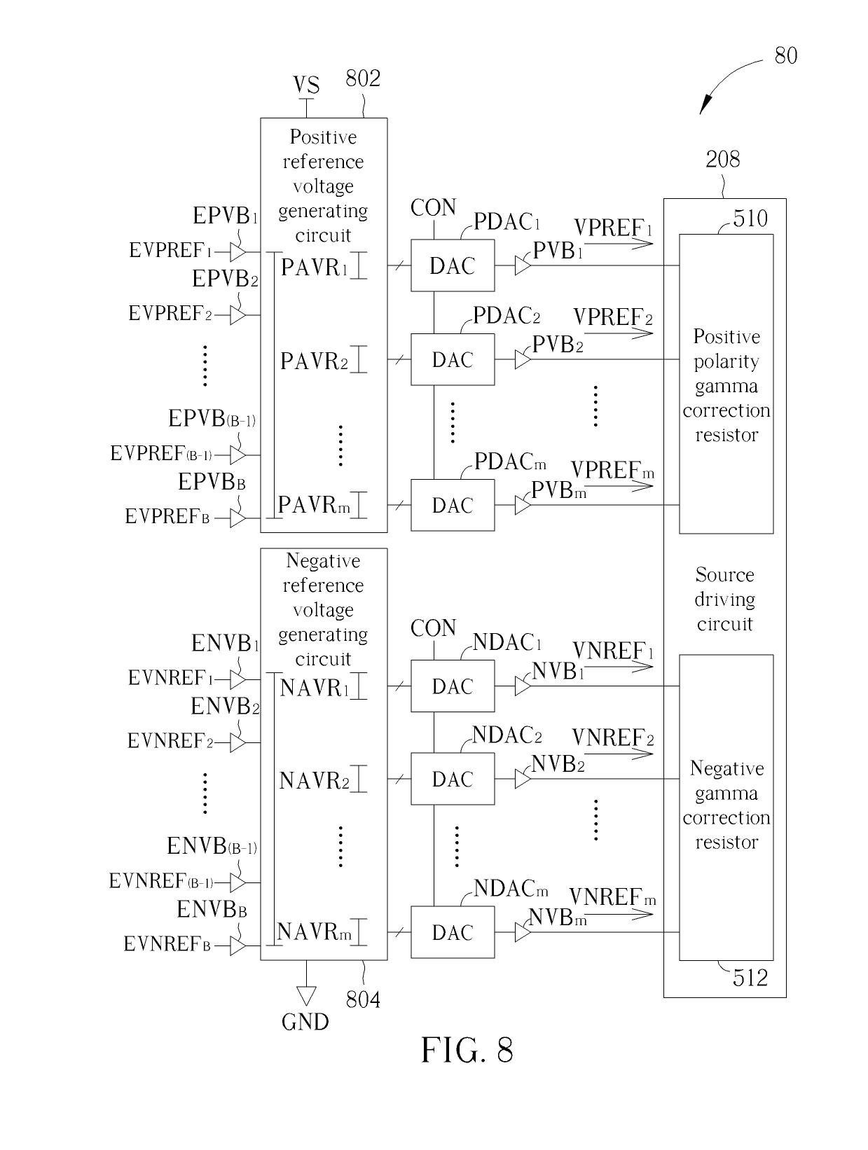

Moreover, please refer to FIG. 8, which is a schematic diagram of a further integrated source driver 80 according to an embodiment of the present invention. As shown in FIG. 8, the integrated source driver 80 and integrated source driver 60 are the same in parts, and thus elements and signals with similar functions are denoted by the same symbol. The main difference between the integrated source driver 80 and the integrated source driver 60 is that the integrated source driver 80 comprises a positive reference voltage generating circuit 802 and a negative reference voltage generating circuit 804 (can be integrated into a reference voltage generating circuit), for receiving external reference voltages EVPREF₁-EVPREF_{B}, EVNREF₁-EVNREF_{B}, respectively, and providing at least one of adjust voltage range PAVR₁-PAVRₘ, NAVR₁-NAVRₘ within the supply voltage VS and the ground level GND according to the external reference voltage EVPREF₁-EVPREF_{B}, EVNREF₁-EVNREF_{B}.

The positive reference voltage generating circuit 802 and the negative reference voltage generating circuit 804 in the embodiment shown in FIG. 8 receive the stable external reference voltages EVPREF₁-EVPREF_{B}, EVNREF₁-EVNREF_{B} provided and buffered by voltage buffers EPVB₁-EPVB_{B}, ENVB₁-ENVB_{B} as reference voltage points. Therefore, the reference voltage points are stable within the supply voltage VS and the ground level GND, and are capable of generating stable adjustable voltage ranges PAVR₁-PAVRₘ, NAVR₁-NAVRₘ, wherein the external reference voltage EVPREF₁ is a maximum positive reference voltage, the external reference voltage EVPREF_{B} is a minimum positive reference voltage, the external reference voltage EVNREF₁ is a maximum negative reference voltage and external reference voltage EVNREF_{B} is a minimum negative reference voltage.

In such a condition, since the external reference voltage EVPREF₁, EVPREF_{B}, EVNREF₁, EVNREF_{B} are stable reference voltage points, the positive reference voltage range and the negative reference voltage range of the positive reference voltage generating circuit 802 and the negative reference voltage generating circuit 804 can be clearly defined, to avoid accumulated errors from resistor division voltage and increase the accuracy of generating the internal reference voltages VPREF₁-VPREFₘ, VNREF₁-VNREFₘ. Noticeably, the present invention generates the internal reference voltages VPREF₁-VPREFₘ, VNREF₁-VNREFₘ via integration, to reduce the external reference voltage points, and thus saves the system cost and dynamically adjusts the reference voltages. Therefore, the number of the external reference voltage EVPREF₁-EVPREF_{B}, EVNREF₁-EVNREF_{B} received from an external system in FIG. 8 should be less than that of the required internal reference voltages VPREF₁-VPREFₘ, VNREF₁-VNREFₘ (i.e. 2B<2m), to achieve the advantages of integration.

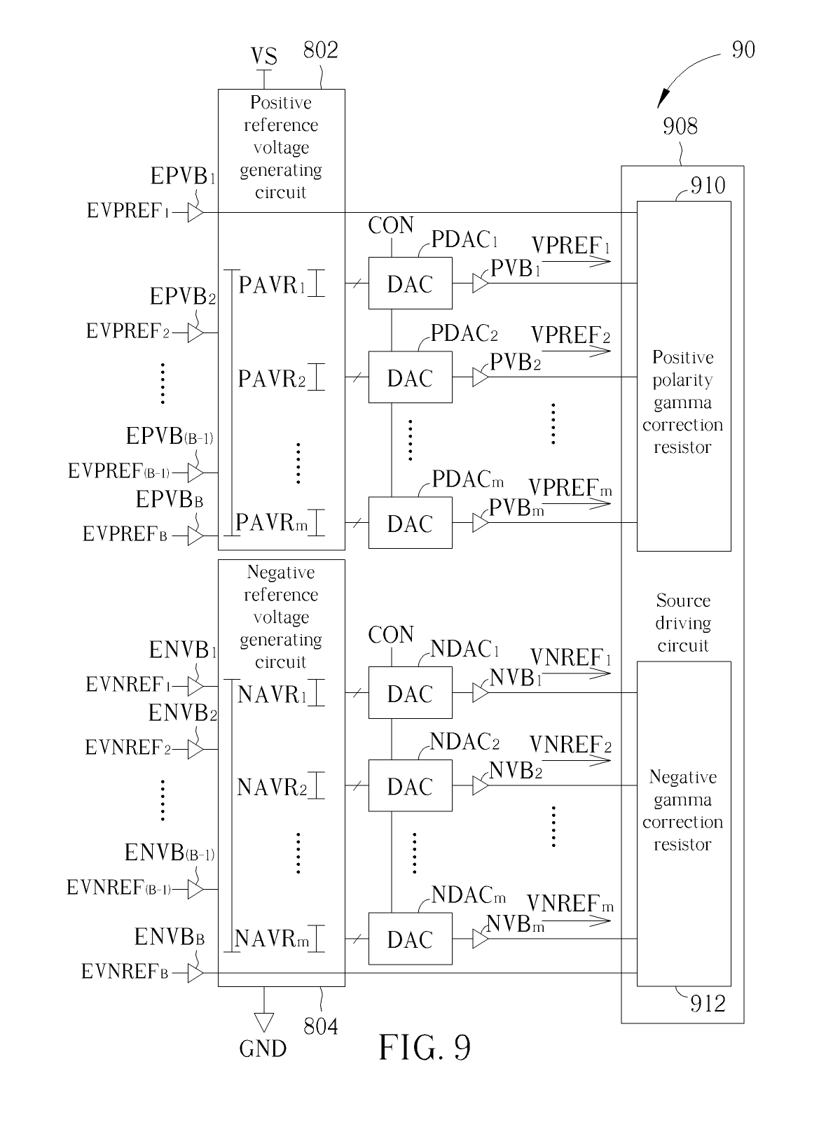

In addition, please refer to FIG. 9, which is a schematic diagram of a further integrated source driver 90 according to an embodiment of the present invention. As shown in FIG. 9, the integrated source driver 90 and the integrated source driver 80 are the same in parts, and thus elements and signals with similar functions are denoted by the same symbol. The main difference between the integrated source driver 90 and the integrated source driver 80 is that a source driving circuit 908 included in the integrated source driver 90 receives external reference voltage EVPREF₁, EVNREF_{B} by a positive polarity gamma correction resistor 910 and a negative polarity gamma correction resistor 912, and then performs driving according to internal reference voltages VPREF₂-VPREFₘ, VNREF₁-VNREFₘ₋₁ and the external reference voltages EVPREF₁, EVNREF_{B}. The external reference voltage EVPREF₁ is a maximum positive reference voltage and the external reference voltage EVNREF_{B} is a minimum negative reference voltage. In such a condition, since the external reference voltage EVPREF₁, EVNREF_{B} is also adjustable within a specific voltage range thereof, the source driving circuit 908 is capable of directly receiving the external reference voltages EVPREF₁, EVNREF_{B} from an external system, to replace the internal reference voltages VPREF₁, VNREFₘ generated inside, so as to save the hardware cost of the corresponding digital to analog converters PDAC₁, NDACₘ and positive voltage buffers PVB₁, NVBₘ.

Noticeably, the reference voltage generating circuit and the source driving circuit in the above embodiment receive the external reference voltages with specific voltage levels and specific numbers, respectively, for having stable reference voltage points and saving hardware cost. However, the reference voltage generating circuit and the source driving circuit in other embodiments may receive external reference voltages with other voltage levels and other numbers, respectively, according to practical requirements, and still have stable reference voltage points and save hardware cost. Besides, FIGS. 5 to 9 are embodiments of a single integrated source driver. However, a plurality of source drivers are required to drive pixels of corresponding data lines, respectively, in a panel application of a general liquid crystal display device. Therefore, a plurality of integrated source drivers may be utilized in other embodiments for the panel application of the liquid crystal display device.

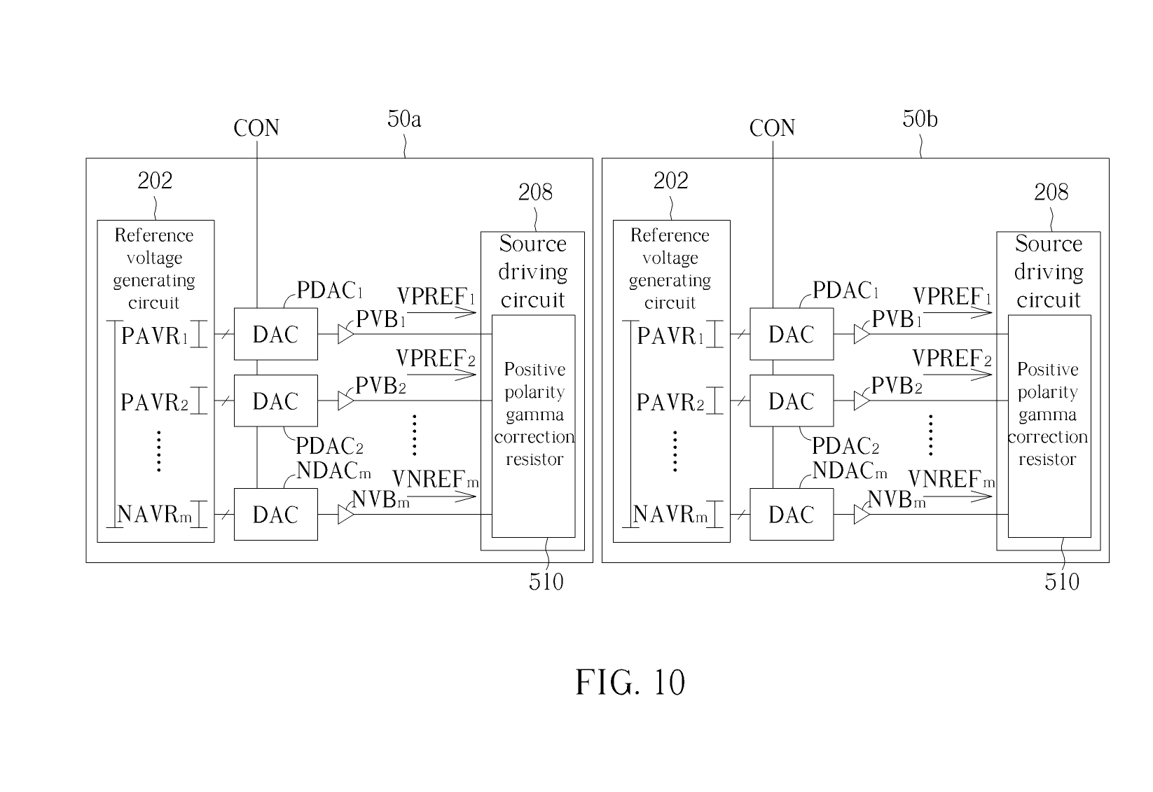

For example, please refer to FIG. 10, which is a schematic diagram of integrated source drivers 50a, 50b in a panel application according to an embodiment of the present invention. The integrated source drivers 50a, 50b and the integrated source driver 50 are completely the same, and thus denotation is omitted for simplicity. In such a condition, the integrated source drivers 50a, 50b directly generate internal reference voltages within the supply voltage and the ground level for driving pixels of corresponding data lines in the plurality of data lines, respectively. Therefore, the external system only needs to provide the control signal CON and no need for providing external reference voltages.

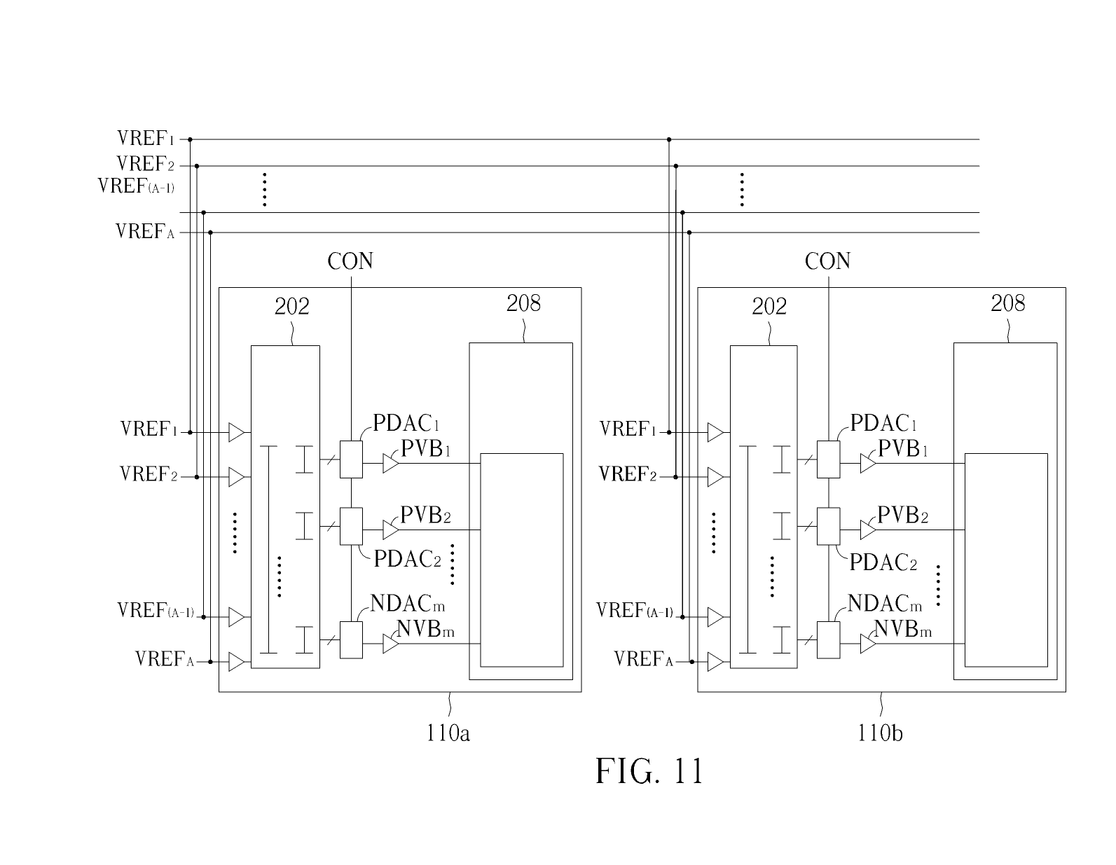

Besides, please refer to FIG. 11, which is a schematic diagram of integrated source drivers 110a, 110b in a panel application according to an embodiment of the present invention. The integrated source driver 110a, 110b can be realized by at least one of the integrated source driver 60, 70, 80, 90, and thus denotation is omitted for simplicity. In such a condition, the integrated source driver 110a, 110b receive stable external reference voltages VREF₁-VREF_{A} as the reference voltage points, and then generate internal reference voltages to drive pixels of corresponding data lines. Therefore, the external system may provide the external reference voltages VREF₁-VREF_{A} for both the integrated source driver 110a, 110b.

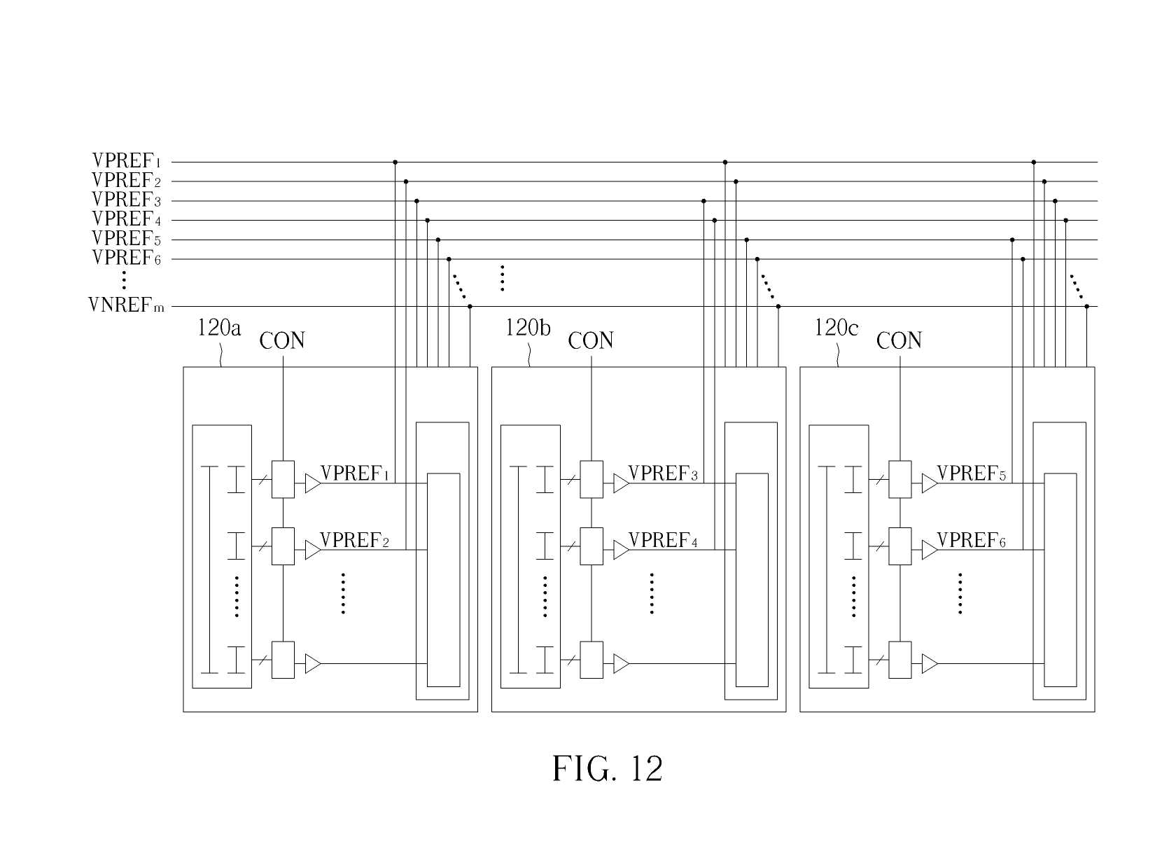

Moreover, please refer to FIG. 12, which is a schematic diagram of integrated source drivers 120a, 120b, 120c in a panel application according to an embodiment of the present invention. The integrated source drivers 120a, 120b, 120c are partially the same with at least one of the integrated source drivers 60, 70, 80, 90, and thus denotation is omitted for simplicity. The main difference between the integrated source drivers 120a, 120b, 120c and at least one of the integrated source driver 60, 70, 80, 90 is that the integrated source driver 120a generates internal reference voltages VPREF₁-VPREF₂ and provides internal reference voltages VPREF₁-VPREF₂ for the integrated source drivers 120b, 120c for driving. In such a situation, the integrated source drivers 120b, 120c directly receive the internal reference voltages VPREF₁-VPREF₂ generated by the integrated source driver 120a, and thus save hardware cost of corresponding digital to analog converters and positive voltage buffers. By the same token, the integrated source driver 120b provides internal reference voltages VPREF₃-VPREF₄ for the integrated source drivers 120a, 120c so as to save hardware cost of corresponding digital to analog converters and positive voltage buffers. The integrated source driver 120c provides internal reference voltages VPREF₅-VPREF₆ for the integrated source drivers 120a, 120b so as to save hardware cost of corresponding digital to analog converters and positive voltage buffers. As a result, since internal reference voltages generated by control signal CON inside an integrated source driver are not limited only for the integrated source stage driver itself, each integrated source driver may generate partial internal reference voltages for other integrated source drivers, respectively, and internal reference voltages generated by other integrated source drivers may be used as external reference voltages shown in FIGS. 6 to 9. Reference voltage points are therefore reduced or not required from external systems.

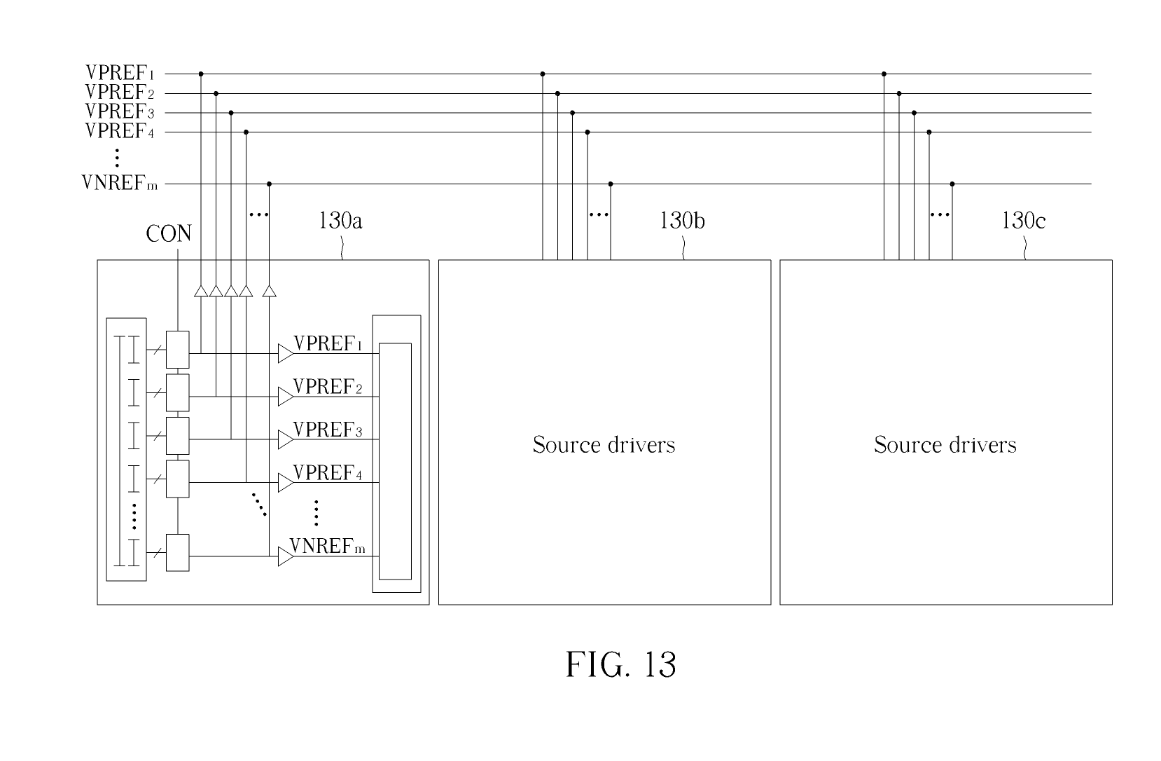

Furthermore, please refer to FIG. 13, which is a schematic diagram of an integrated source driver 130a and source drivers 130b, 130c in a panel application according to an embodiment of the present invention. The integrated source driver 130a and the integrated source driver 50a are the same in parts, and thus denotation is omitted for simplicity. The main difference between the integrated source driver 130a and the integrated source driver 50 is that the integrated source driver 130a provides all internal reference voltages VPREF₁-VPREFₘ, VNREF₁-VNREFₘ to the source drivers 130b, 130c for driving after generating internal reference voltage VPREF₁-VPREFₘ, VNREF₁-VNREFₘ. In such a situation, the source drivers 130b, 130c directly receive the internal reference voltage VPREF₁-VPREFₘ, VNREF₁-VNREFₘ generated all by the integrated source driver 130a, and thus completely save hardware cost of corresponding digital to analog converters and positive voltage buffers (i.e. the integrated source drivers 130b, 130c are similar to the conventional source driver 10).

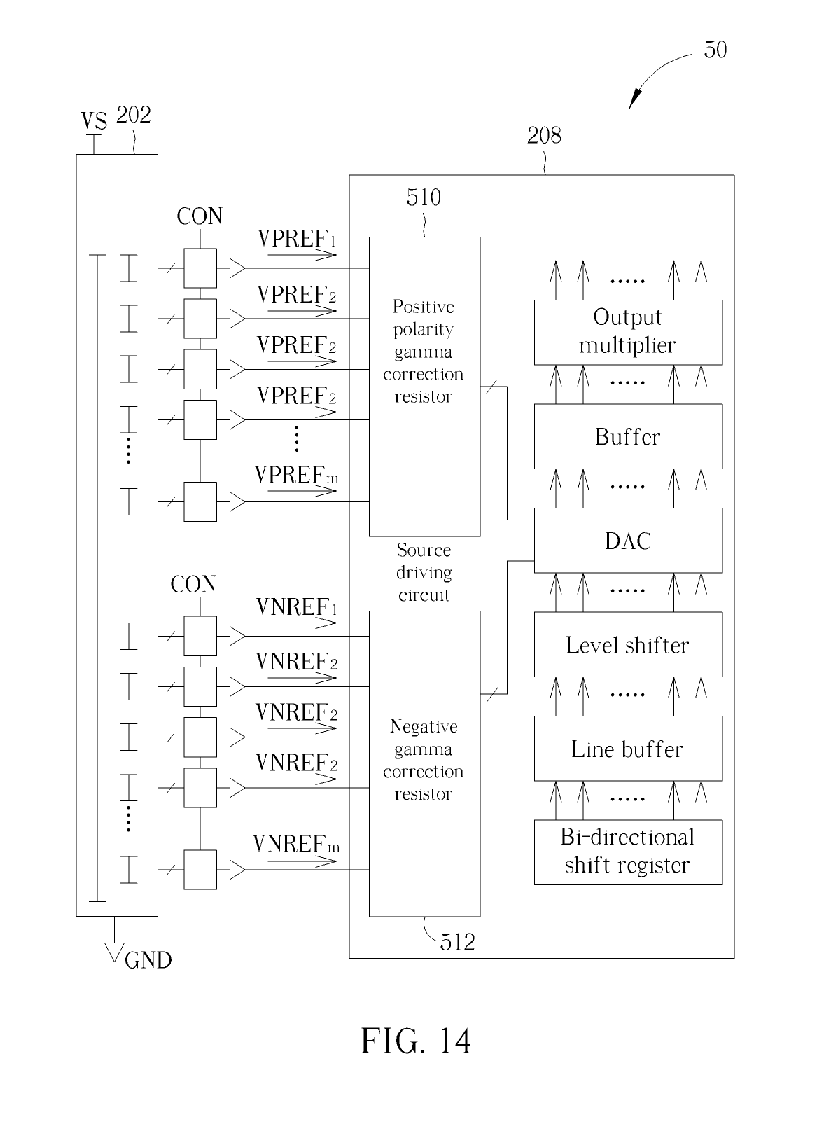

Noticeably, the integrated source driver 130a in the above embodiment integrates external circuits that generate the reference voltages, and generates the internal reference voltages to drive source driving circuit. The circuits that are integrated are different from those that perform driving based on reference voltages in the original source driver. In detail, please refer to FIG. 14, which is a detailed schematic diagram of the integrated source driver 50 shown in FIG. 5. As shown in FIG. 14, the positive polarity gamma correction resistor 510 and the negative polarity gamma correction resistor 512 receive internal reference voltages VPREF₁-VPREFₘ, VNREF₁-VNREFₘ and then deliver to the voltages to the digital to analog converter in the source driving circuit 208 for selecting (the digital to analog converter herein is not the same as the digital to analog converters PDAC₁-PDACₘ, NDAC₁-NDACₘ). Therefore, a bi-directional shift register, a line buffer, a level shifter, a digital to analog converter, a buffer, and an output multiplier are utilized in the source driving circuit 208 to output a correct voltage level for driving. This part is well-known for those skilled in the art, and hence is not narrated hereinafter.

In the prior art, if the conventional external reference voltage generator 12 and the conventional source driver 10 are directly integrated into an integrated source driver, and if adjustable ranges of reference voltages are still the same with the rail-to-rail adjustable ranges of the conventional external reference voltage generator 12 while maintaining high resolution, hardware cost is quite large because the source driver 10 requires a large amount of reference voltages. In comparison, the present invention minimizes corresponding adjustable voltage ranges PAVR₁-PAVRₘ, NAVR₁-NAVRₘ according to practical applications when integrating to generate the internal reference voltages VPREF₁-VPREFₘ, VNREF₁-VNREFₘ, to achieve higher resolution for the same hardware cost, or require less hardware for the same resolution.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated source driver for a liquid crystal display device, comprising:
a reference voltage generating circuit, for providing a plurality of adjustable voltage ranges within a supply voltage and a ground level; and
a reference voltage selecting circuit, comprising a plurality of digital to analog converters (DACs), for selecting and generating a plurality of internal reference voltages from the plurality of adjustable voltage ranges according to a control signal, respectively;
wherein the plurality of adjustable voltage ranges decrease progressively.

2. The integrated source driver of claim 1 further comprising:
a plurality of first voltage buffers, coupled to the plurality of digital to analog converters, respectively, for buffering the plurality of internal reference voltages; and
a source driving circuit, for driving according to the plurality of internal reference voltages received from the plurality of first voltage buffers.

3. The integrated source driver of claim 1, wherein the reference voltage generating circuit receives at least one first external reference voltage, and provides at least one of the plurality of adjustable voltage ranges within the supply voltage and the ground level according to the at least one first external reference voltage.

4. The integrated source driver of claim 3, wherein a plurality of second voltage buffers buffer the at least one first external reference voltage.

5. The integrated source driver of claim 3, wherein a number of the at least one first external reference voltage is less than a number of the plurality of internal reference voltages.

6. The integrated source driver of claim 1 further comprising a source driving circuit, for receiving at least one second external reference voltage, and driving according to the plurality of internal reference voltages and the at least one second external reference voltage.

7. The integrated source driver of claim 3, wherein the at least one first external reference voltage comprises a maximum positive reference voltage, a minimum positive reference voltage, a maximum negative reference voltage and a minimum negative reference voltage.

8. The integrated source driver of claim 6, wherein the at least one second external reference voltage comprises a maximum positive reference voltage and a minimum negative reference voltage.

9. A liquid crystal display device, comprising:
a plurality of data lines; and
a plurality of integrated source drivers, for driving pixels of corresponding data lines in the plurality of data lines, respectively, wherein a first integrated source driver in the plurality of integrated source drivers comprises:
a reference voltage generating circuit, for providing a plurality of adjustable voltage ranges within a power supply voltage and a ground level; and
a reference voltage selecting circuit, comprising a plurality of digital to analog converters (DACs), for selecting and generating a plurality of first internal reference voltages from the plurality of adjustable voltage ranges according to a control signal, respectively;
wherein the plurality of adjustable voltage ranges decrease progressively.

10. The liquid crystal display device of claim 9, wherein the first integrated source driver further comprising:
a plurality of first voltage buffers, coupled to the plurality of digital to analog converters, respectively, for buffering the plurality of internal reference voltages; and
a source driving circuit, for driving according to the plurality of internal reference voltages received from the plurality of first voltage buffers.

11. The liquid crystal display device of claim 9, wherein the reference voltage generating circuit receives at least one first external reference voltage, and provides at least one of the plurality of adjustable voltage ranges within the supply voltage and the ground level according to the at least one first external reference voltage.

12. The liquid crystal display device of claim 11, wherein a plurality of second voltage buffers buffer the at least one first external reference voltage.

13. The liquid crystal display device of claim 11, wherein a number of the at least one first external reference voltage is less than a number of the plurality of internal reference voltages.

14. The liquid crystal display device of claim 9, wherein the first integrated source driver further comprising a source driving circuit, for receiving at least one second external reference voltage, and driving according to the plurality of internal reference voltages and the at least one second external reference voltage.

15. The liquid crystal display device of claim 11, wherein the at least one first external reference voltage comprises a maximum positive reference voltage, a minimum positive reference voltage, a maximum negative reference voltage and a minimum negative reference voltage.

16. The liquid crystal display device of claim 14, wherein the at least one second external reference voltage comprises a maximum positive reference voltage and a minimum negative reference voltage.

17. The liquid crystal display device of claim 9, wherein the first integrated source driver provides the plurality of first internal reference voltages for a second integrated source driver in the plurality of integrated source drivers to perform driving.

18. The liquid crystal display device of claim 17, wherein the first integrated source driver performs driving by receiving a plurality of second internal reference voltages from a second integrated source driver in the plurality of integrated source drivers.
